(19) United States
(12) Patent Application Publication
(10) Pub. No.: US 2003/0011808 A1
(43) Pub. Date: Jan. 16, 2003

(54) Printable personal digital assistant

(76) Inventor: Chih-Ta Wu, Taipei (TW)

Correspondence Address: CONNOLLY BOVE LODGE & HUTZ, LLP, 1220 N MARKET STREET, P O BOX 2207, WILMINGTON, DE, 19899

(21) Appl. No.: 09/903,449

(22) Filed: Jul. 11, 2001

(51) Int. Cl. B41J 1/00; G06F 15/00

(52) U.S. Cl. 358/1.15

(57) ABSTRACT

A printable personal digital assistant mainly is a personal digital assistance associated with a printing device. In addition to the original functions such as management and record, the data to be recorded on a preset paper can be performed by the printing device. Hence, the data in the personal digital assistant can be printed out promptly as needed.

### BACKGROUND OF THE INVENTION

1. Field of the Invention

The present invention relates to a printable personal digital assistant, more particularly, to a personal digital assistant associated, which is possible to convert the data therein into a written form on paper promptly.

2. Description of Related Art

The personal digital assistant is a mini computer device, which is light in weight and thin in thickness so as to be carried conveniently, so that functions such as the record of personal events, the personal administration data, the record with regard to the personal communicated information, and the personal amusement can be performed by the user easily and handily. Thus, the user can control his working schedule instantly, carry out the work has to be done, and look into the data needed instantly in a few seconds by way of operating the personal digital assistant such that the utilization of time can be controlled effectively and the work done can be controlled efficiently. Furthermore, it is possible for the personal digital assistant to provide an interface in conjunction with an ordinary personal computer such that a demand of speeding up the transmission of information can be satisfied by the contemporaries.

The personal digital assistant provides a screen of liquid crystal display and a plurality of simple and understandable icons can be shown on the screen to represent database such as a time display, a character memorandum, financial management, a schedule of appointments, a name card with telephone number, and an icon memorandum. An electronic pen can be used to touch a selected icon item so as to perform an expected function.

Besides, the personal digital assistant further provides a serial port or an infrared port to connect with another personal digital assistant for transmitting data to each other. Moreover, a modem can be connected to the personal digital assistant for sending or receiving e-mails. Hence, the personal digital assistant can offer multiple functions for diversified purposes.

Mostly, the personal digital assistant available on the market can be classified into two different types, and one is an ordinary type and the other is a professional type.

The ordinary type of personal digital assistant generally refers to a personal digital assistant offering common functions such as an address book, a calendar, a notebook, and a list of matters to be done.

The professional type of personal digital assistant refers to a personal digital assistant offering a specific use such as transmitting update quotations in the stock market, or acting as an electronic dictionary.

However, the preceding personal digital assistant is unable to convert the data therein into a written document on a piece of paper when it is necessary although a variety of functions can be performed effectively.

### SUMMARY OF THE INVENTION

An object of the present invention is to provide a printable personal digital assistant, which is in conjunction with a printing device to offer a written document promptly when it is needed.

### BRIEF DESCRIPTIN OF THE DRAWINGS

Other objects and features of the present invention can be more fully understood by reference to the following description of a preferred embodiment and accompanying drawings, in which:

FIG. 1 is a perspective view of a printable personal digital assistant according to the present invention;

FIG. 2 is a fragmentary sectional view of the printable personal digital assistant shown in FIG. 1;

FIG. 3 is a perspective view of a paper feed box provided in the printable personal digital assistant of the present invention;

FIG. 4 is a perspective view illustrating the paper feed box to be mounted to the personal digital assistant;

FIG. 5 is a flow chart of an operation system according to the present invention;

FIG. 6 is a block diagram of the operation system according to the present invention; and

FIG. 7 is a simplified circuit diagram with regard to the present invention.

### DETAILED DESCRIPTION OF THE PREFERRED EMBODIMENT

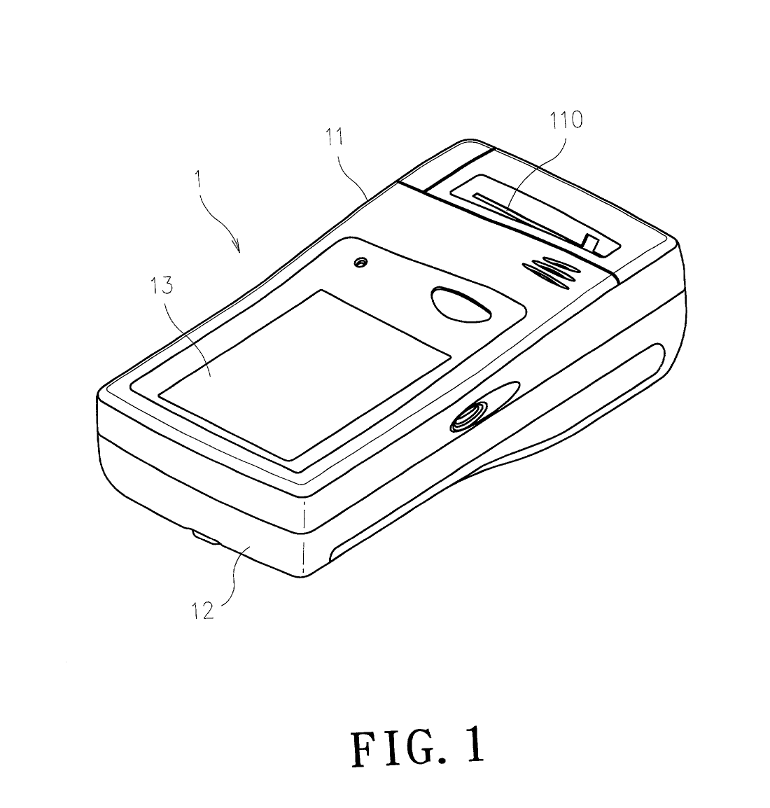

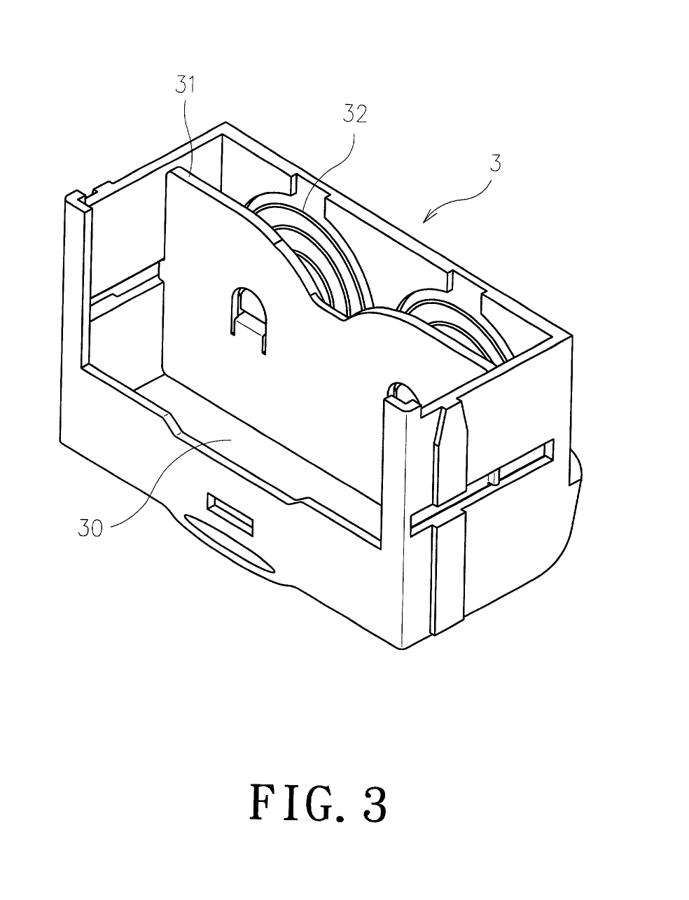

Referring to FIGS. 1 to 4, the printable personal digital assistant of the present invention comprises a personal digital assistant 1, a printing device 2, and a paper feed box 3.

Wherein, the personal digital assistant 1 further comprises a central processor, a screen display 13, and a power source. The personal digital assistant 1 provides a structural arrangement similar to the conventional one so that no detail will be described further.

The personal digital assistant 1 has an upper casing part 11 attached next to the screen display 13 and a feed slot 110 corresponding to a paper outlet of the printing device 2.

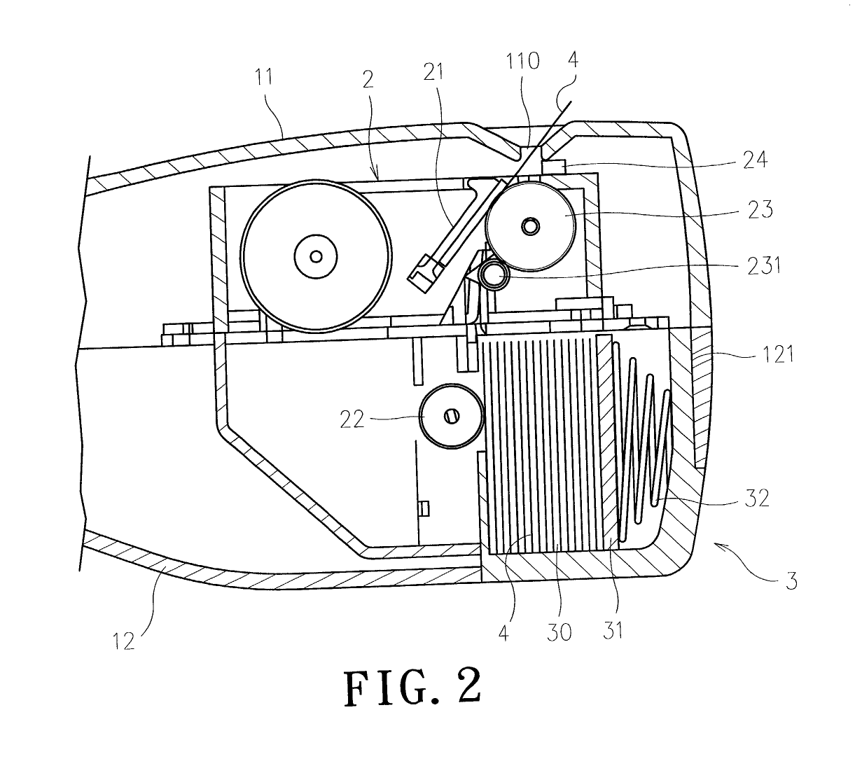

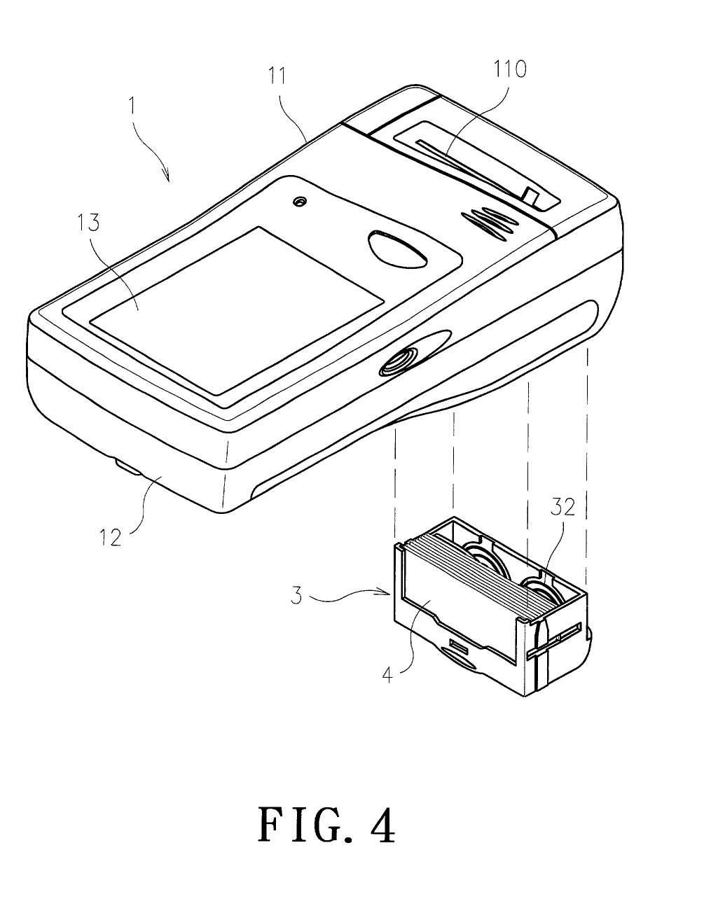

The printing device 2 may be mounted in the upper casing part 11 and provides with a thermal induced print head 21 and conveying wheels 23, 231. The print head 21 at the paper outlet thereof has a sensor 24. A lower casing part 12 is disposed opposite to the upper casing part 11 and provides a recess opening 121 under the print head 21 to receive the paper feed box 3 as shown in FIGS. 2 and 4.

Referring to FIGS. 2 3 and 4 again, the paper feed box 3 has a shape corresponding to the recess opening 121 and has a containing space 30 with a push plate 31 and a spring 32. The containing space 30 can receive a pile of paper sheets 4 and the whole pile of paper sheets 4 are kept in a state of moving forward by way of the push plate 31 associated with the spring 32.

A transmitting wheel 22 is disposed in the lower casing part 12 next to the papers 4 and is opposite to the push plate 31. The transmitting wheel 22 is driven by a step motor and keeps contact with the papers 4 in the paper feed box 3.

The pile of paper sheet 4 in the paper feed box 3 is provided with a high sensitivity to the heat, and the maximum capacity of the paper feed box 3 is approximately 100 sheets of papers.

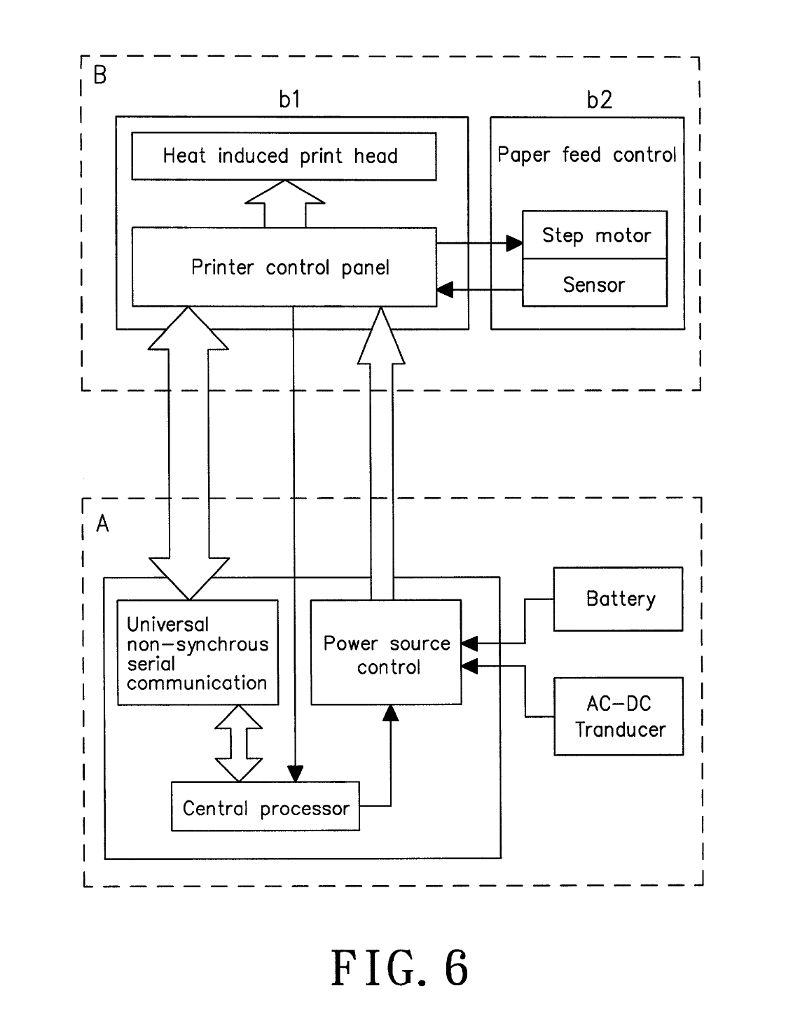

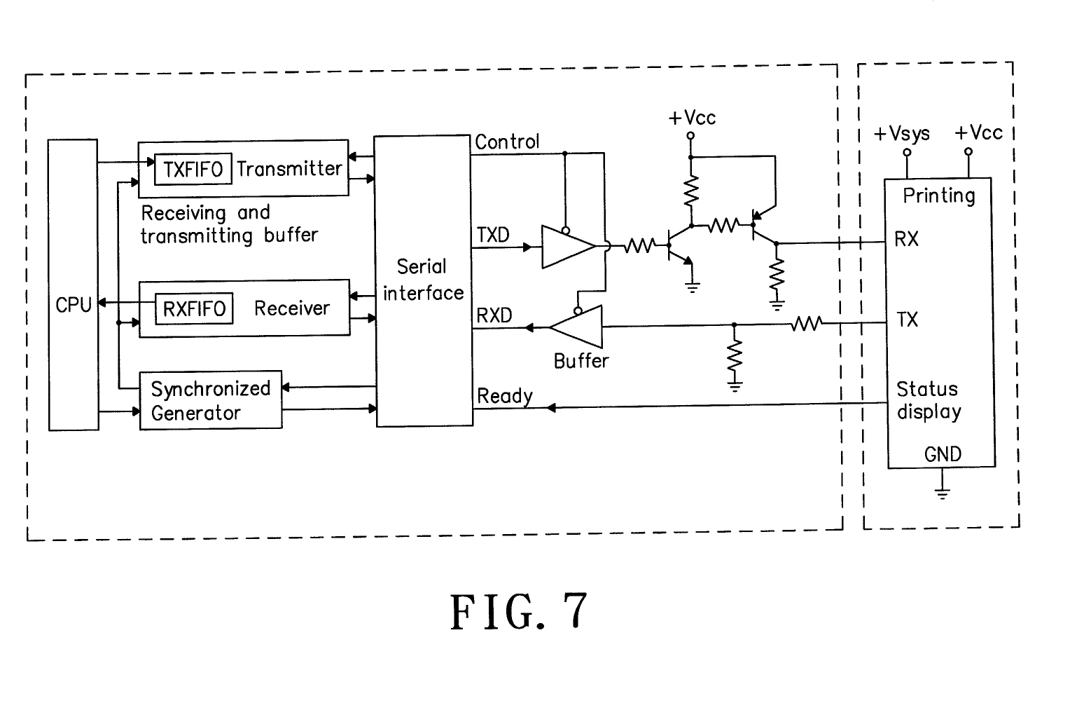

Referring to FIGS. 6 and 7, basically the printable personal digital assistant of the present invention can be divided into a unit A and a unit B from the block diagram illustrated in FIG. 6. The unit A is like an ordinary control unit of management and comprises the central processor, a power source control, and a universal non-synchronous serial communication. The unit B is a device executing print function, and comprises a printing device b1, and a paper feed control b2, and a circuit shown in FIG. 7 illustrates the relationship among the preceding devices.

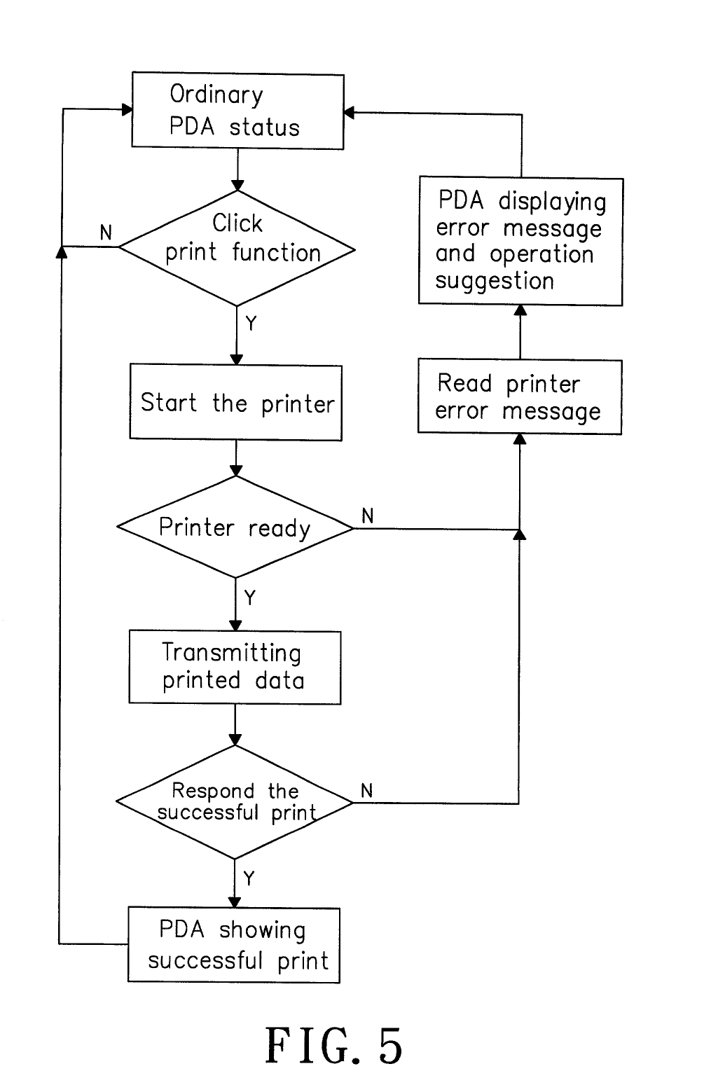

When the printable personal digital assistant is in operation, a pile of paper sheets with a high sensitivity to the heat are placed in the paper feed box 3, and the paper feed box 3 is inserted into the recess opening 121 of the lower casing part 12 firstly. The transmitting wheel 22 rotates and moves one of paper sheets 4 upward to enter the printing device 2 as soon as the control unit in the personal digital assistant sends out a print signal. The paper 4 in the printing device 2 is thermally sensed by the heat induced print head 21 and it can be delivered outward via the feed slot 110 on the upper casing 11 by way of the conveying wheels 231, 23 once the paper 4 is successfully printed. The sensor 24 is disposed at the out let of the printing head 21 to detect if the paper 4 is successfully printed, that is, once there is no normal output of printed paper under an expected execution of printing function, an error message and an operation suggestion may appear on the display screen. A flow chart with regard to the operation of the printable personal digital assistant is shown in FIG. 5.

Furthermore, the shape of the paper feed box 3 can be changed to meet any specific need of use and any desirable need of function such as the direction of paper feed, the capacity thereof, or the mode for engaging with the lower casing.

While the invention has been described with reference to a preferred embodiment thereof, it is to be understood that modifications or variations may be easily made without departing from the spirit of this invention, which is defined by the appended claims.

What is claimed is:

1. A printable personal digital assistant, comprising
a housing, being composed of an upper and a lower casing parts, providing a paper feed slot;
a display screen, being mounted on the housing as a communication interface between the personal digital assistant and a user;
a central processor, being disposed in the housing as a principal operation unit;
a power source device, being disposed in the housing for offering an electric power needed by the personal digital assistant;
a printing device, being disposed in the housing, providing a printing mechanism with a plurality of conveying wheels for printing and delivering a sheet of paper; and
a paper feed device, being disposed corresponding to the printing device, receiving a single sheet of paper or a pile of paper sheets for being fed into the printing device by a transmitting wheel.

2. The printable personal digital assistant according to claim 1, wherein the paper feed device is a paper feed box engaging with a recess opening located at the lower casing part, and a receiving space in the paper feed device provides a push plate being biased by an elastic element such as a spring or a plate spring.

3. The printable personal digital assistant according to claim 1, wherein the printing mechanism is a heat induced printer, and the paper is high sensible to the heat.

4. The printable personal digital assistant according to claim 1, wherein the papers may be a pile of paper sheets.

5. The printable personal digital assistant according to claim 1, wherein the printing device at an outlet thereof provides a sensor to detect if the papers is normally operated.
